(19) United States
(12) Patent Application Publication
(10) Pub. No.: US 2026/0161789 A1
(43) Pub. Date: Jun. 11, 2026

(54) INFORMATION PROCESSING SYSTEM, INFORMATION PROCESSING APPARATUS, AND DATA COMMUNICATION METHOD

(71) Applicant: Lenovo (Singapore) Pte. Ltd., Singapore (SG)

(72) Inventors: Fangge Sun, Kanagawa (JP); Yusaku Morishige, Kanagawa (JP); Ken Sasaki, Kanagawa (JP); Mikio Hagiwara, Kanagawa (JP)

(73) Assignee: Lenovo (Singapore) Pte. Ltd., Singapore (SG)

(21) Appl. No.: 19/300,100

(22) Filed: Aug. 14, 2025

(30) Foreign Application Priority Data
Aug. 20, 2024 (JP) 2024-138976

(51) Int. Cl. G06F 21/57; H04L 9/08; H04L 9/14; H04L 9/30

(52) U.S. Cl. CPC G06F 21/575; H04L 9/0866; H04L 9/0891; H04L 9/14; H04L 9/3073; G06F 2221/034

(57) ABSTRACT

In an information processing system, an information processing apparatus stores a first public key in a first key pair held by a server apparatus, and transmits a second public key in a second key pair to an upper apparatus. The upper apparatus transmits, to the server apparatus, a third public key in a third key pair and the second public key. The server apparatus generates encrypted data obtained by encrypting the third public key with a first private key and the second public key, and transmits the encrypted data to the information processing apparatus, the information processing apparatus decrypts the encrypted data with the first public key and a second private key to acquire the third public key, the upper apparatus encrypts update data with a common key for data communication based on the second public key and a third private key.

### CROSS-REFERENCE TO RELATED APPLICATIONS

This application claims priority to Japanese Patent Application No. 2024-138976 filed on Aug. 20, 2024, the contents of which are hereby incorporated herein by reference in their entirety.

### TECHNICAL FIELD

Embodiments of the present invention relate to an information processing system, an information processing apparatus, and a data communication method.

### BACKGROUND

An information processing apparatus such as a PC (Personal Computer) is internally equipped with a nonvolatile memory (for example, a flash ROM (Read Only Memory)) in which a program for running a system such as a BIOS (Basic Input Output System) is stored. The information processing apparatus boots up the system by running this program to execute various information processing (for example, see Japanese Unexamined Patent Application Publication No. 2014-010492).

When data of the program written in this nonvolatile memory is corrupted, or when an incorrect program is written into the memory, it is impossible to boot up the system normally. In such a case, as a method of restoring data inside the nonvolatile memory, the data are restored by connecting an upper device such as a ROM writer and the nonvolatile memory via a prescribed interface, and transmitting the restored data to the nonvolatile memory.

However, in the conventional technology described above, there is a possibility that the program might be illegally tampered with, for example, by transmitting illegal data from an invalid upper device to the nonvolatile memory.

### SUMMARY

Embodiments of the present invention provide an information processing system, an information processing apparatus, and a data communication method capable of updating data in a nonvolatile memory properly while ensuring security.

An information processing system according to the first aspect of the present invention includes: an information processing apparatus having a rewritable nonvolatile storage unit which stores a program for booting up an OS (Operating System) to execute processing based on the OS; a server apparatus which manages the information processing apparatus; and an upper apparatus which can communicate with the information processing apparatus and the server apparatus to transmit update data of the program to the information processing apparatus, wherein the information processing apparatus includes a registered public key storage unit which stores a first public key corresponding to the information processing apparatus in a first key pair of the first public key and a first private key held by the server apparatus, the information processing apparatus executes first processing to generate a second key pair of a second public key and a second private key and to transmit the second public key in the second key pair to the upper apparatus, the upper apparatus executes second processing to generate a third key pair of a third public key and a third private key and to transmit the third public key in the third key pair and the second public key to the server apparatus, the server apparatus executes third processing to generate encrypted data obtained by encrypting the third public key based on the first private key and the second public key when the legitimacy of a user of the upper apparatus is confirmed, and to transmit the encrypted data to the information processing apparatus through the upper apparatus, the information processing apparatus executes fourth processing to decrypt the encrypted data based on the first public key and the second private key so as to generate the third public key, the upper apparatus executes fifth processing to generate a common key for data communication based on the second public key and the third private key, to encrypt the update data based on the common key for data communication so as to generate encrypted update data, and to transmit the encrypted update data to the information processing apparatus, and the information processing apparatus executes sixth processing to generate the common key for data communication based on the second private key and the third public key, to decrypt the encrypted update data based on the common key for data communication so as to generate the update data, and to update the program stored in the nonvolatile storage unit based on the update data.

The above information processing system according to the first aspect of the present invention may be such that in the third processing, the server apparatus generates a first shared secret key based on the first private key and the second public key, and encrypts the third public key based on the generated first shared secret key to generate the encrypted data, and in the fourth processing, the information processing apparatus generates a second shared secret key based on the first public key and the second private key, and decrypts the encrypted data based on the generated second shared secret key to generate the third public key.

The above information processing system according to the first aspect of the present invention may also be such that each of the first key pair, the second key pair, and the third key pair is a key pair of a public key and a private key in elliptic curve cryptography, the first shared secret key and the second shared secret key are an identical common key, and the common key is shared between the server apparatus and the information processing apparatus using an elliptic curve Diffie-Hellman key exchange method, and the common key for data communication is shared between the upper apparatus and the information processing apparatus using the elliptic curve Diffie-Hellman key exchange method.

The above information processing system according to the first aspect of the present invention may further be such that the server apparatus encrypts the third public key using common key cryptography, and the upper apparatus encrypts the update data using common key cryptography.

Further, the above information processing system according to the first aspect of the present invention may be such that the information processing apparatus includes a main control unit which boots up the OS by executing the program stored in the nonvolatile storage unit to execute processing based on the OS, and a sub control unit communicable with the upper apparatus and operable independently of the main control unit to execute the first processing, the fourth processing, and the sixth processing.

Further, the above information processing system according to the first aspect of the present invention may be such that a program of a BIOS (Basic Input Output System) is included as the program, the nonvolatile storage unit is a flash memory having a SPI (Serial Peripheral Interface) bus, and the sub control unit updates the program of the BIOS in the flash memory using the SPI bus.

Further, the second aspect of the present invention is an information processing apparatus for an information processing apparatus including: the information processing apparatus having a rewritable nonvolatile storage unit which stores a program for booting up an OS (Operating System) to execute processing based on the OS; a server apparatus which manages the information processing apparatus; and an upper apparatus which can communicate with the information processing apparatus and the server apparatus to transmit update data of the program to the information processing apparatus, the information processing apparatus including: a registered public key storage unit which stores a first public key corresponding to the information processing apparatus in a first key pair of the first public key and a first private key held by the server apparatus; a key pair generation unit which generates a second key pair of a second public key and a second private key; a public key exchange unit which acquires encrypted data generated by the server apparatus encrypting a third public key in a third key pair of the third public key and a third private key generated by the upper apparatus based on the first private key and the second public key after the information processing apparatus transmits the second public key in the second key pair to the upper apparatus, decrypts the encrypted data based on the first public key and the second private key stored in the registered public key storage unit to generate the third public key; a common key generation unit which generates a common key for data communication based on the third public key decrypted by the public key exchange unit and the second private key; and an update processing unit which decrypts the encrypted update data received from the upper apparatus based on the common key for data communication generated by the common key generation unit to update the program stored in the nonvolatile storage unit based on the decrypted update data.

Further, the third aspect of the present invention is a data communication method for an information processing system including: an information processing apparatus having a rewritable nonvolatile storage unit which stores a program for booting up an OS (Operating System) to execute processing based on the OS; a server apparatus which manages the information processing apparatus; and an upper apparatus which can communicate with the information processing apparatus and the server apparatus to transmit update data of the program to the information processing apparatus, where the information processing apparatus includes a registered public key storage unit which stores a first public key corresponding to the information processing apparatus in a first key pair of the first public key and a first private key held by the server apparatus, the data communication method including: a first processing step of causing the information processing apparatus to generate a second key pair of a second public key and a second private key and to transmit the second public key in the second key pair to the upper apparatus; a second processing step of causing the upper apparatus to generate a third key pair of a third public key and a third private key and to transmit the third public key in the third key pair and the second public key to the server apparatus; a third processing step of causing the server apparatus to generate encrypted data obtained by encrypting the third public key based on the first private key and the second public key when the legitimacy of a user of the upper apparatus is confirmed, and to transmit the encrypted data to the information processing apparatus through the upper apparatus; a fourth processing step of causing the information processing apparatus to decrypt the encrypted data based on the first public key and the second private key so as to generate the third public key; a fifth processing step of causing the upper apparatus to generate a common key for data communication based on the second public key and the third private key, to encrypt the update data based on the common key for data communication so as to generate encrypted update data, and to transmit the encrypted update data to the information processing apparatus; and a sixth processing step of causing the information processing apparatus to generate the common key for data communication based on the second private key and the third public key, to decrypt the encrypted update data based on the common key for data communication so as to generate the update data, and to update the program stored in the nonvolatile storage unit based on the update data.

Embodiments of the present invention can update data in the nonvolatile memory properly while ensuring security.

### BRIEF DESCRIPTION OF THE DRAWINGS

FIG. 1 is a configuration diagram illustrating an example of an information processing system according to one or more embodiments.

FIG. 2 is a block diagram illustrating an example of a main hardware configuration of a laptop PC according to one or more embodiments.

FIG. 3 is a functional block diagram illustrating an example of the functional configuration of the information processing system according to one or more embodiments.

FIG. 4 is a flowchart illustrating an example of BIOS update processing of the information processing system according to one or more embodiments.

FIG. 5 is a first diagram for describing a state of the BIOS update processing of the information processing system according to one or more embodiments.

FIG. 6 is a second diagram for describing the state of the BIOS update processing of the information processing system according to one or more embodiments.

FIG. 7 is a third diagram for describing the state of the BIOS update processing of the information processing system according to one or more embodiments.

FIG. 8 is a fourth diagram for describing the state of the BIOS update processing of the information processing system according to one or more embodiments.

FIG. 9 is a fifth diagram for describing the state of the BIOS update processing of the information processing system according to one or more embodiments.

FIG. 10 is a sixth diagram for describing the state of the BIOS update processing of the information processing system according to one or more embodiments.

FIG. 11 is a seventh diagram for describing the state of the BIOS update processing of the information processing system according to one or more embodiments.

### DETAILED DESCRIPTION

An information processing system, an information processing apparatus, and a data communication method according to one or more embodiments of the present invention will be described below with reference to the accompanying drawings.

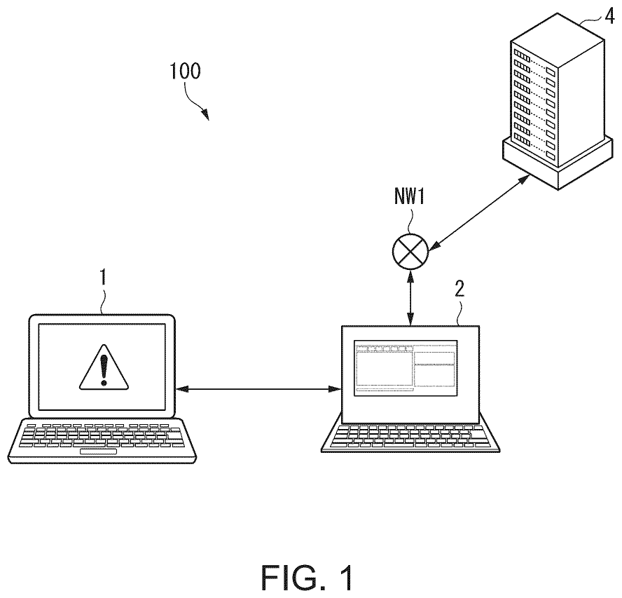

FIG. 1 is a configuration diagram illustrating an example of an information processing system 100 according to one or more embodiments.

As illustrated in FIG. 1, the information processing system 100 includes a laptop PC 1, a host apparatus 2, and a management server 4.

The laptop PC 1 is an information processing apparatus having a rewritable nonvolatile storage unit that stores a program (for example, a BIOS) for booting up an OS (Operating System) to execute processing based on the OS. The laptop PC 1 is a target apparatus in the information processing system 100, which is an apparatus targeted for restoring and updating the BIOS, for example, when data of the BIOS is corrupted and hence the BIOS cannot be booted up. Note that the detailed configuration of the laptop PC 1 will be described later.

The host apparatus 2 (an example of an upper apparatus) is an information processing apparatus communicable with the laptop PC 1 and the management server 4, which is used, for example, to update the BIOS of the laptop PC 1 (for example, to restore a program of the BIOS the data of which is corrupted). For example, the host apparatus 2 is a laptop PC similar to the laptop PC 1, a desktop PC, or the like. For example, the host apparatus 2 is an upper apparatus used by a maintenance worker when data in a BIOS memory 32 of the laptop PC 1 is corrupted and hence the laptop PC 1 cannot be booted up.

The management server 4 is a server apparatus managed, for example, by a manufacturer of the laptop PC 1, which can be connected to the host apparatus 2 through a network NW1. The management server 4 holds a private key and a public key corresponding to each laptop PC 1. The management server 4 is used for update processing of the program of the BIOS (which may also be called the BIOS program below).

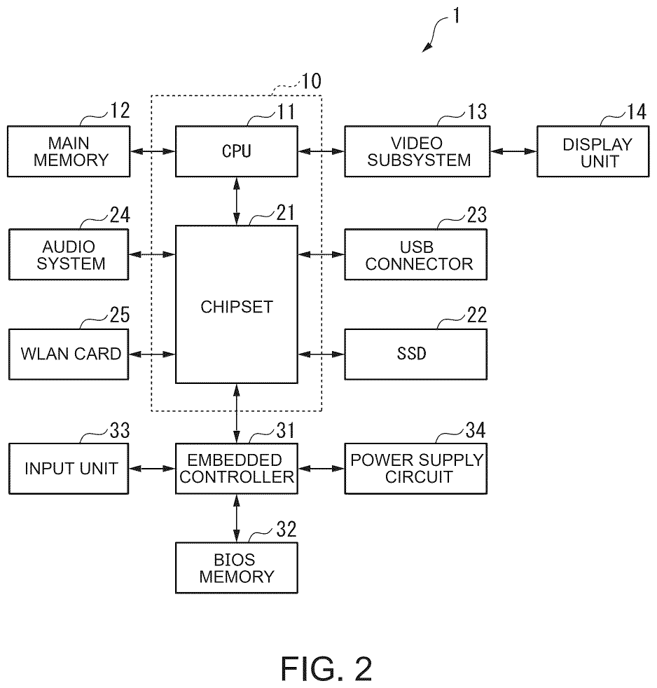

Referring next to FIG. 2, a main hardware configuration of the laptop PC 1 will be described. FIG. 2 is a diagram illustrating an example of the main hardware configuration of the laptop PC 1 according to one or more embodiments.

As illustrated in FIG. 2, the laptop PC 1 includes a CPU 11, a main memory 12, a video subsystem 13, a display unit 14, a chipset 21, an SSD 22, a USB connector 23, an audio system 24, a WLAN card 25, an embedded controller 31, the BIOS memory 32, an input unit 33, and a power supply circuit 34.

Note that the CPU 11 and the chipset 21 correspond to a main control unit 10 in one or more embodiments. Further, the main control unit 10 is an example of a processor (main processor) that executes a program stored in a memory (the main memory 12).

The CPU (Central Processing Unit) 11 executes various kinds of arithmetic processing by program control to control the entire laptop PC 1.

The main memory 12 is a writable memory used as reading areas of execution programs of the CPU 11 or working areas to which processed data of the execution programs are written. The main memory 12 is composed, for example, of plural DRAM (Dynamic Random Access Memory) chips. The execution programs include the BIOS, the OS, various drivers for hardware-operating peripheral devices, various services/utilities, application programs, and the like.

Further, the main memory 12 is an example of a system memory that stores programs and data, which is equipped in the laptop PC 1 by a DIMM on which the plural DRAMs are mounted.

The video subsystem 13 is a subsystem for implementing a function related to image display, which includes a video controller. This video controller processes drawing instructions from the CPU 11, writes processed drawing information into a video memory, and reads this drawing information from the video memory to output the drawing information to the display unit 14 as drawing data (display data).

The display unit 14 is, for example, a liquid crystal display to display a display screen based on the drawing data (display data) output from the video subsystem 13.

The chipset 21 includes controllers such as for USB, serial ATA (AT Attachment), an SPI (Serial Peripheral Interface) bus, a PCI (Peripheral Component Interconnect) bus, a PCI-Express bus, and an LPC (Low Pin Count) bus, and plural devices are connected thereto. In FIG. 2, as examples of devices, the SSD 22, the USB connector 23, the audio system 24, and the WLAN card 25 are connected to the chipset 21.

The SSD (Solid State Drive) 22 (an example of a nonvolatile storage unit) stores the OS, various drivers, various services/utilities, application programs, and various data.

The USB connector 23 is a connector for connecting peripheral devices using the USB. It is assumed that the USB connector 23 includes, for example, a USB type-C connector.

The audio system 24 records, plays back, and outputs sound data.

The WLAN (Wireless Local Area Network) card 25 is connected to a network through wireless LAN to perform data communication.

The embedded controller 31 (an example of a sub control unit) is a one-chip microcomputer which monitors and controls various devices (peripheral devices, sensors, and the like) regardless of the system state of the laptop PC 1. Further, the embedded controller 31 has a power management function to control the power supply circuit 34. Note that the embedded controller 31 is composed of a CPU, a ROM, a RAM, and the like, which are not illustrated, and includes multi-channel A/D input terminal and D/A output terminal, a timer, and digital input/output terminals. To the embedded controller 31, for example, the BIOS memory 32, the input unit 33, the power supply circuit 34, and the like are connected through these input/output terminals. The embedded controller 31 controls the operation of these units.

Note that the embedded controller 31 has an SPI bus, and connected to the BIOS memory 32 through the SPI bus. In one or more embodiments, the BIOS memory 32 is connected to the embedded controller 31, for example, by a Slave Attached Flash method, and the main control unit 10 is accessible to the BIOS memory 32 via the embedded controller 31 connected by the eSPI bus.

The embedded controller 31 is operable in such a state that no power is supplied to the main control unit 10, which can communicate with the host apparatus 2 without going through the main control unit 10, and can access the BIOS memory 32 without going through the main control unit 10.

The BIOS memory 32 is configured, for example, by an electrically rewritable nonvolatile memory such as an EEPROM (Electrically Erasable Programmable Read Only Memory) or a flash ROM. The BIOS memory 32 stores a BIOS program and the like. The BIOS memory 32 is connected to the embedded controller 31 by the SPI bus.

The input unit 33 is, for example, an input unit including a keyboard, a pointing device, a touch pad, and the like.

The power supply circuit 34 includes, for example, a DC/Dc converter, a charge/discharge unit, a battery unit, an AC/DC adapter, and the like to convert DC voltage supplied from the AC/DC adapter or the battery unit into plural voltages required to operate the laptop PC 1. Further, the power supply circuit 34 supplies power to each unit of the laptop PC 1 under the control of the embedded controller 31.

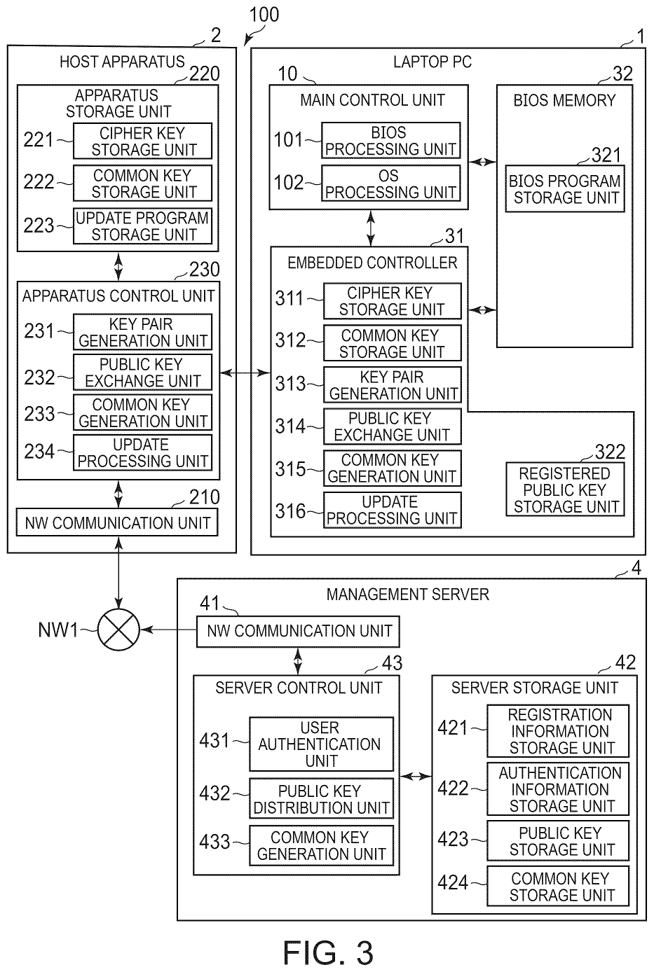

Referring next to FIG. 3, the functional configuration of the information processing system 100 according to one or more embodiments will be described.

FIG. 3 is a functional block diagram illustrating an example of the functional configuration of the information processing system 100 according to one or more embodiments. Note that in FIG. 3, only components related to the present invention are illustrated among functional components included in the information processing system 100.

As illustrated in FIG. 3, the information processing system 100 includes the laptop PC 1, the host apparatus 2, and the management server 4.

The management server 4 includes a NW communication unit 41, a server storage unit 42, and a server control unit 43.

The NW (Net Work) communication unit 41 is a network adapter connectable to the network NW1, for example, by wired LAN or the like, which can be connected to the host apparatus 2 through the network NW1.

The server storage unit 42 is a storage unit realized, for example, by a RAM, an SSD or an HDD, or the like to store various information used by the management server 4. The server storage unit 42 includes a registration information storage unit 421, an authentication information storage unit 422, a public key storage unit 423, and a common key storage unit 424.

The registration information storage unit 421 stores registration information on each laptop PC 1 manufactured and shipped by the manufacturer. For example, the registration information storage unit 421 stores the serial number of the laptop PC 1, a public key, and a private key in association with one another.

Here, the serial number is an example of identification information for identifying the laptop PC 1. Further, the public key and the private key are a key pair (public key and private key) in public key cryptography assigned to the laptop PC 1 concerned. In one or more embodiments, one key pair is assigned to one laptop PC 1. Further, it is assumed that the public key and the private key stored in the registration information storage unit 421 are a first public key and a first private key, and a key pair of the first public key and the first private key is a first key pair.

The authentication information storage unit 422 stores information for authenticating a user of the host apparatus 2 to be described later. For example, the authentication information storage unit 422 stores authentication information for logging in to the management server 4 such as a user ID, a password, and the like.

The public key storage unit 423 stores a public key (second public key) generated by the laptop PC 1, and a public key (third public key) generated by the host apparatus 2. The second public key and the third public key are acquired from the host apparatus 2 through the NW communication unit 41.

The common key storage unit 424 stores a shared secret key (first shared secret key) shared between the management server 4 and the laptop PC 1. The shared secret key (first shared secret key) stored in the common key storage unit 424 is used to distribute, to the laptop PC 1, the third public key as a public key of the host apparatus 2.

The server control unit 43 is a functional unit implemented, for example, by causing an unillustrated CPU to execute a program stored in the server storage unit 42. The server control unit 43 executes registration processing for the serial number, the public key, and the private key stored in the registration information storage unit 421, processing for securely distributing the public key (third public key) of the host apparatus 2 to the laptop PC 1 to update (restore) the BIOS program stored in the BIOS memory 32 of the laptop PC 1, and the like.

The server control unit 43 includes a user authentication unit 431, a public key distribution unit 432, and a common key generation unit 433.

The user authentication unit 431 executes user authentication processing for a user of the host apparatus 2 based on authentication information stored in the authentication information storage unit 422. For example, the user authentication unit 431 confirms the legitimacy of the user of the host apparatus 2 depending on whether or not login information (the user ID and the password) transmitted from the host apparatus 2 matches the user ID and the password stored in the authentication information storage unit 422. When the user ID and the password transmitted from the host apparatus 2 match the user ID and the password stored in the authentication information storage unit 422, the user authentication unit 431 allows processing of the public key distribution unit 432 and the common key generation unit 433 to be described below.

The public key distribution unit 432 receives the public key (second public key) of the laptop PC 1 and the public key (third public key) of the host apparatus 2 from the host apparatus 2 through the NW communication unit 41, and encrypts the public key (third public key) of the host apparatus 2 based on the first private key stored in the registration information storage unit 421, and the public key (second public key) of the laptop PC 1 to generate encrypted data (encrypted third public key). The public key distribution unit 432 stores, in the public key storage unit 423, the second public key and the third public key received from the host apparatus 2.

The public key distribution unit 432 encrypts the third public key, for example, using a shared secret key (first shared secret key) generated by the common key generation unit 433 based on the first private key and the second public key to be described later. For example, using the AES (Advanced Encryption Standard) as the common key cryptography, the public key distribution unit 432 performs encryption processing of the third public key with the first shared secret key to generate the encrypted data. Note that the public key distribution unit 432 generates the encrypted data when the legitimacy of the user of the host apparatus 2 is confirmed by the user authentication unit 431.

The public key distribution unit 432 distributes the encrypted data as the encrypted third public key to the laptop PC 1 through the NW communication unit 41 and the host apparatus 2.

When the legitimacy of the user of the host apparatus 2 is confirmed by the user authentication unit 431, the common key generation unit 433 generates the shared secret key (first shared secret key) based on the first private key and the second public key. Here, for example, the first private key and the second public key are a private key and a public key in elliptic-curve cryptography.

Note that a first key pair of a first public key Q1 (x1, y1) and a first private key d1 is expressed by Equation (1) below.

$$Q 1 ( x 1 , y 1 ) = d 1 \times G ( xg , yg ) \qquad ( 1 )$$

G(xg, yg) is a base point of an elliptic curve, and the base point G(xg, yg) is multiplied by d1 as the first private key d1 to generate the first public key Q1(x1, y1) as a point on the elliptic curve. Further, a second key pair of a second public key Q2(x2, y2) and a second private key d2 is expressed by Equation (2) below. Further, a third key pair of a third public key Q3(x3, y3) and a third private key d3 is expressed by Equation (3) below.

$$Q 2 ( x 2 , y 2 ) = d 2 \times G ( xg , yg ) \qquad ( 2 )$$

$$Q 3 ( x 3 , y 3 ) = d 3 \times G ( xg , yg ) \qquad ( 3 )$$

For example, using Equation (4) below, the common key generation unit 433 generates a shared secret key K1 (first shared secret key) based on the first private key d1 and the second public key Q2 (x2, y2).

$$K 1 = d 1 \times Q 2 ( x 2 , y 2 ) = d 1 \times d 2 \times G ( xg , yg ) \qquad ( 4 )$$

The common key generation unit 433 may set, as the first shared secret key as is, K1 in Equation (4) described above, or may further process K1 using, for example, a hash function or a key derivation function (for example, a KDF or the like) to generate the first shared secret key. The common key generation unit 433 stores the generated first shared secret key in the common key storage unit 424.

Further, the public key distribution unit 432 encrypts the third public key using the first shared secret key generated by the common key generation unit 433. In other words, the public key distribution unit 432 encrypts the third public key, for example, by the AES or the like using the first shared secret key stored in the common key storage unit 424 to generate encrypted data.

The laptop PC 1 includes the main control unit 10, the embedded controller 31, and the BIOS memory 32.

The BIOS memory 32 includes a BIOS program storage unit 321. Note that the BIOS memory 32 is accessible from the embedded controller 31 via the SPI bus using a Slave Attached Flash method.

In the Slave Attached Flash method, the embedded controller 31 as a slave is connected to the main control unit 10 as a master, and the BIOS memory 32 as a slave is connected to the embedded controller 31. These connections enable access from the embedded controller 31 to the BIOS memory 32, and access from the main control unit 10 to the BIOS memory 32 via the embedded controller 31.

The BIOS program storage unit 321 stores the BIOS program. Note that when data of the BIOS program stored in the BIOS program storage unit 321 is corrupted, the main control unit 10 cannot boot up the OS. In such a case, update data of the BIOS program is written into the BIOS program storage unit 321 using the host apparatus 2 to restore the data of the BIOS program so as to restore the laptop PC 1 to a state of being able to boot up the OS.

The main control unit 10 is a functional unit implemented by causing the CPU 11 to execute programs stored in the SSD 22, the BIOS memory 32, the main memory 12, and the like. The main control unit 10 executes processing based on the OS and the BIOS. For example, the main control unit 10 includes a BIOS processing unit 101 and an OS processing unit 102.

The BIOS processing unit 101 is a functional unit implemented, for example, by causing the CPU 11 to execute the BIOS program stored in the BIOS memory 32, which executes processing based on the BIOS.

The OS processing unit 102 is a functional unit implemented, for example, by causing the CPU 11 to execute an OS program stored in the SSD 22, which executes processing based on the OS.

The embedded controller 31 is a control unit operable in a state where power is not supplied to the main control unit 10, which executes BIOS update processing and the like when the laptop PC 1 and the host apparatus 2 are connected.

The embedded controller 31 includes a registered public key storage unit 322, a cipher key storage unit 311, a common key storage unit 312, a key pair generation unit 313, a public key exchange unit 314, a common key generation unit 315, and an update processing unit 316.

The registered public key storage unit 322 stores the first public key registered when the laptop PC 1 is shipped. The registered public key storage unit 322 stores the first public key assigned to the laptop PC 1. Note that the registered public key storage unit 322 may also store the first public key in association with the serial number of the laptop PC 1.

Note that the registered public key storage unit 322 is provided in a firmware area of the embedded controller 31 for the BIOS memory 32, which is realized as a storage unit capable of being accessed only from the firmware of the embedded controller 31.

The cipher key storage unit 311 is a storage unit realized, for example, by an unillustrated RAM or the like included in the embedded controller 31, which stores the second key pair (the key pair of the second private key and the second public key), and the third public key.

The common key storage unit 312 is a storage unit realized, for example, by the unillustrated RAM or the like included in the embedded controller 31, which stores a second shared secret key generated by the common key generation unit 315 to be described later, and a common key for data communication.

The key pair generation unit 313 is a functional unit implemented, for example, by causing an unillustrated CPU included in the embedded controller 31 to execute a program stored in an unillustrated ROM. The key pair generation unit 313 generates, as a one-time key pair, the second key pair as a key pair in elliptic curve cryptography. For example, the key pair generation unit 313 generates the second private key d2 based on random numbers, and generates the second public key Q2(x2, y2) using Equation (2) described above. The key pair generation unit 313 stores the generated second key pair in the cipher key storage unit 311.

The common key generation unit 315 is a functional unit implemented, for example, by causing the unillustrated CPU included in the embedded controller 31 to execute a program stored in the unillustrated ROM. The common key generation unit 315 generates the shared secret key (second shared secret key) based on the first public key stored in the registered public key storage unit 322, and the second private key in the second private key pair stored in the cipher key storage unit 311.

The common key generation unit 315 generates a second shared secret key K2 from the first public key Q1(x1, y1) and the second private key d2 using Equation (5) below.

$$K 2 = d 2 \times Q 1 ( x 1 , y 1 ) \qquad ( 5 )$$

Note that, as expressed in Equation (6) below, the second shared secret key K2 becomes the same value as that of the first shared secret key K1 by substituting Equation (1) described above. The common key generation unit 315 stores the generated second shared secret key K2 in the common key storage unit 312.

$$K 2 = d 2 \times Q 1 ( x 1 , y 1 ) = d 2 \times d 1 \times G ( xg , yg ) = K 1 \qquad ( 6 )$$

As the sharing method of this common key (the shared secret key), an elliptic curve Diffie-Hellman key exchange method is used, and in one or more embodiments, the common key (the shared secret key) is shared between the management server 4 and the laptop PC 1 using the elliptic curve Diffie-Hellman key exchange method.

Further, the common key generation unit 315 generates a common key for data communication as a shared secret key (shared secret key K4) based on the second private key in the second key pair stored in the cipher key storage unit 311, and the public key (third public key) of the host apparatus 2. For example, the common key generation unit 315 generates a fourth shared secret key K4 from the third public key Q3(x3, y3) and the second private key d2 using Equation (7) below.

$$K 4 = d 2 \times Q 3 ( x 3 , y 3 ) = d 2 \times d 3 \times G ( xg , yg ) \qquad ( 7 )$$

The common key generation unit 315 may also use K4 in Equation (7) described above as is as the common key for data communication, or may further process K4 using, for example, the hash function or the key derivation function (for example, the KDF or the like) to generate the common key for data communication. The common key generation unit 315 stores the generated fourth shared secret key K4 in the common key storage unit 312.

The public key exchange unit 314 is a functional unit implemented, for example, by causing the unillustrated CPU included in the embedded controller 31 to execute a program stored in the unillustrated ROM. The public key exchange unit 314 transmits, to the host apparatus 2, the second public key in the second key pair.

Further, based on the first public key and the second private key stored in the cipher key storage unit 311, the public key exchange unit 314 decrypts the encrypted data generated by the management server 4 to generate the third public key. The public key exchange unit 314 decrypts the encrypted data received from the host apparatus 2, for example, by the AES or the like using the second shared secret key K2 (=the first shared secret key K1) generated by the common key generation unit 315 to generate a third public key. The public key exchange unit 314 stores the generated third public key in the cipher key storage unit 311.

The update processing unit 316 is a functional unit implemented, for example, by causing the unillustrated CPU included in the embedded controller 31 to execute a program stored in the unillustrated ROM. Based on the common key for data communication (shared secret key K4) generated by the common key generation unit 315, the update processing unit 316 decrypts encrypted update data received from the host apparatus 2 to generate update data. For example, using the common key for data communication (shared secret key K4) stored in the common key storage unit 312, the update processing unit 316 decrypts the encrypted update data, for example, by the AES or the like to generate the update data.

The update processing unit 316 updates the program stored in the BIOS memory 32 based on the decrypted update data. In other words, the update processing unit 316 updates and restores the BIOS program stored in the BIOS program storage unit 321 of the BIOS memory 32 based on the update data.

The host apparatus 2 is connectable with the embedded controller 31 of the laptop PC 1 by a prescribed interface such as USB or a dedicated connector for a motherboard of the laptop PC 1. The host apparatus 2 includes a NW communication unit 210, an apparatus storage unit 220, and an apparatus control unit 230.

The NW communication unit 210 is a network adapter connectable to the network NW1, for example, by wired LAN, wireless LAN, or the like, and connectable with the management server 4 through the network NW1.

The apparatus storage unit 220 is a storage unit realized, for example, by a RAM, an SSD, an HDD, or the like, which stores various information used by the host apparatus 2. The apparatus storage unit 220 includes a cipher key storage unit 221, a common key storage unit 222, and an update program storage unit 223.

The cipher key storage unit 221 is a storage unit realized, for example, by an unillustrated RAM or the like included in the host apparatus 2, which stores the third key pair (the key pair of the third private key and the third public key), and the second public key.

The common key storage unit 222 is a storage unit realized, for example, by the unillustrated RAM or the like included in the host apparatus 2, which stores the common key for data communication (third shared secret key) generated by a common key generation unit 233 to be described later.

The update program storage unit 223 is a storage unit realized, for example, by the RAM, an SSD, an HDD, or the like, which stores update data for the BIOS program. The update data stored in the update program storage unit 223 is used to restore data of the BIOS program.

The apparatus control unit 230 is a functional unit implemented, for example, by causing an unillustrated CPU to execute programs stored in the apparatus storage unit 220. The apparatus control unit 230 executes various processing executed by the host apparatus 2.

For example, the apparatus control unit 230 controls BIOS update processing of the laptop PC 1. The apparatus control unit 230 executes BIOS update processing (update processing of the BIOS program) on the laptop PC 1 through the embedded controller 31.

The apparatus control unit 230 includes a key pair generation unit 231, a public key exchange unit 232, the common key generation unit 233, and an update processing unit 234.

The key pair generation unit 231 generates, as a one-time key pair, the third key pair as a key pair in elliptic curve cryptography. For example, the key pair generation unit 231 generates the third private key d3 based on random numbers, and generates the third public key Q3(x3, y3) using Equation (3) described above. The key pair generation unit 231 stores the generated third key pair in the cipher key storage unit 221.

The common key generation unit 233 generates a common key for data communication (shared secret key K3) based on the second public key received from the laptop PC 1, and the third private key in the third key pair stored in the cipher key storage unit 221.

For example, using Equation (8) below, the common key generation unit 233 generates the third shared secret key K3 from the second public key Q2(x2, y2) and the third private key d3.

$$K 3 = d 3 \times Q 2 ( x 2 , y 2 ) = d 3 \times d 2 \times G ( xg , yg ) \qquad ( 8 )$$

Note that the common key for data communication (shared secret key K4) generated by the laptop PC 1 described above and the common key for data communication (shared secret key K3) generated by the common key generation unit 233 are the same value.

The common key generation unit 233 may set, as the common key for data communication, K3 in Equation (8) described above as is, or may further process K3 using, for example, the hash function or the key derivation function (for example, the KDF or the like) to generate the common key for data communication. The common key generation unit 233 stores the generated third shared secret key K3 in the common key storage unit 222.

Thus, in one or more embodiments, the common key (the common key for data communication) is shared between the host apparatus 2 and the laptop PC 1 using the elliptic curve Diffie-Hellman key exchange method.

The public key exchange unit 232 transmits, to the management server 4, the third public key in the third key pair and the second public key. The public key exchange unit 232 stores, in the cipher key storage unit 221, the second public key received from the laptop PC 1, and transmits the second public key and the third public key stored in the cipher key storage unit 221 to the management server 4 through the NW communication unit 210.

Further, the public key exchange unit 232 receives cipher data (encrypted third public key) through the NW communication unit 210, and transmits the received cipher data (encrypted third public key) to the laptop PC 1.

Based on the common key for data communication (shared secret key K3) generated by the common key generation unit 233, the update processing unit 234 encrypts update data to generate encrypted update data. Using the common key for data communication (shared secret key K3) stored in the common key storage unit 222, the update processing unit 234 encrypts the update data stored in the update program storage unit 223, for example, by the AES or the like to generate encrypted update data.

The update processing unit 234 transmits the generated encrypted update data to the laptop PC 1 to restore the data of the BIOS program.

Note that the key pair generation unit 231, the public key exchange unit 232, the common key generation unit 233, and the update processing unit 234 may also be implemented, for example, by causing the unillustrated CPU to execute a dedicated application to restore and update the BIOS program.

Next, the operation of the information processing system 100 according to one or more embodiments will be described with reference to the accompanying drawings.

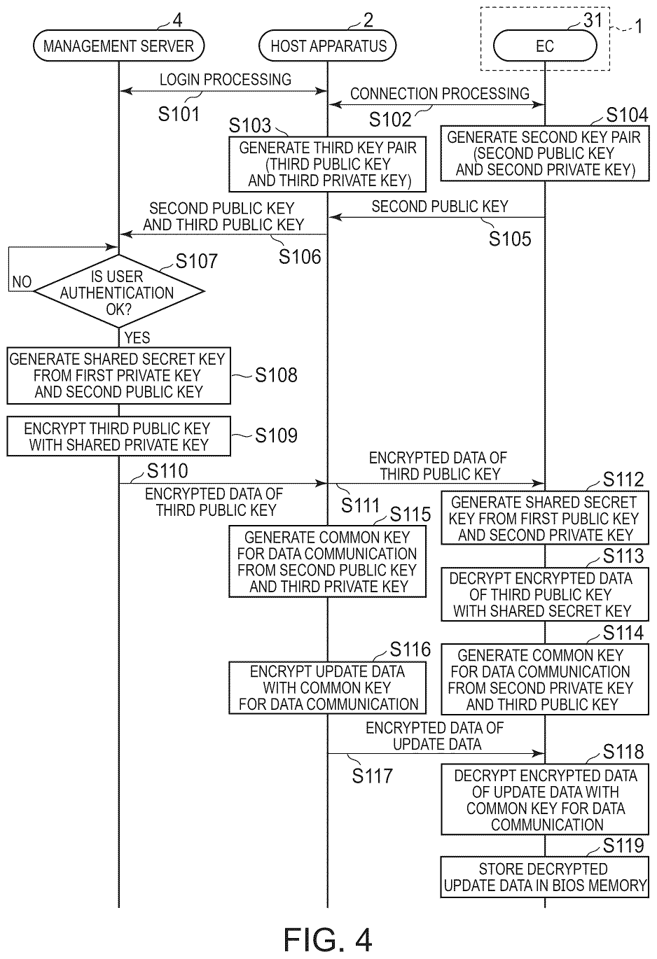

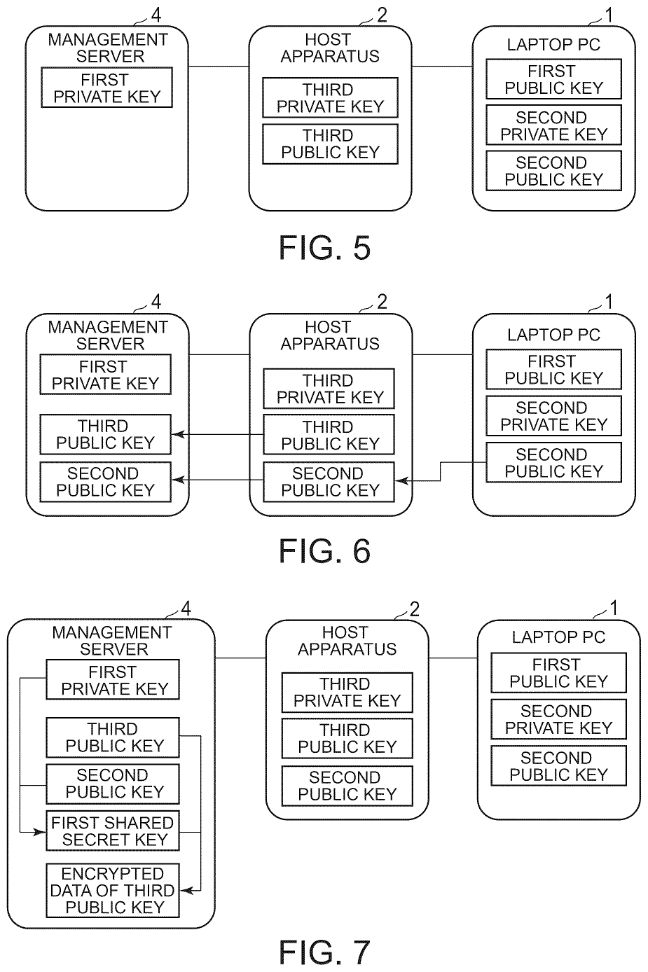

FIG. 4 is a flowchart illustrating an example of BIOS update processing of the information processing system 100 according to one or more embodiments. Further, FIG. 5 to FIG. 11 are diagrams for describing respective states of the BIOS update processing of the information processing system 100 according to one or more embodiments.

As illustrated in FIG. 4, the host apparatus 2 first executes login processing to log in to the management server 4 (step S101). The apparatus control unit 230 of the host apparatus 2 transmits the user ID and the password corresponding to the user of the host apparatus 2 to the management server 4 through the NW communication unit 210 to execute the login processing. The user ID and the password are acquired from the user, for example, through an unillustrated input unit (for example, a keyboard and the like).

Further, for example, the user authentication unit 431 of the management server 4 confirms the legitimacy of the user of the host apparatus 2 depending on whether or not login information (the user ID and the password) transmitted from the host apparatus 2 matches the user ID and the password stored in the authentication information storage unit 422.

Next, the host apparatus 2 executes connection processing with the laptop PC 1 (step S102). The apparatus control unit 230 of the host apparatus 2 activates a prescribed interface connected to the laptop PC 1 to enable communication between the host apparatus 2 and the laptop PC 1 (the embedded controller 31).

Next, the host apparatus 2 generates the third key pair (the third public key and the third private key) (step S103). The key pair generation unit 231 of the host apparatus 2 generates, as a one-time key pair, the third key pair as a key pair in elliptic curve cryptography. For example, the key pair generation unit 231 generates the third private key d3 based on random numbers, and generates the third public key Q3(x3, y3) using Equation (3) described above. The key pair generation unit 231 stores the generated third key pair in the cipher key storage unit 221.

Next, the embedded controller 31 of the laptop PC 1 generates the second key pair (the second public key and the second private key) (step S104). The key pair generation unit 313 of the embedded controller 31 generates, as a one-time key pair, the second key pair as a key pair in elliptic curve cryptography. For example, the key pair generation unit 313 generates the second private key d2 based on random numbers, and generates the second public key Q2(x2, y2) using Equation (2) described above. The key pair generation unit 313 stores the generated second key pair in the cipher key storage unit 311.

Note that the state in FIG. 5 illustrates the state of the information processing system 100 in which the processes up to step S104 are completed. In this state, as illustrated in FIG. 5, the laptop PC 1 (the embedded controller 31) holds the first public key, the second private key, and the second public key, and the host apparatus 2 holds the third private key and the third public key. Further, the management server 4 holds at least the first private key.

Returning to the description of FIG. 4, the embedded controller 31 next transmits the second public key to the host apparatus 2 (step S105). The public key exchange unit 314 of the embedded controller 31 transmits, to the host apparatus 2, the second public key stored in the cipher key storage unit 311.

Next, the host apparatus 2 transmits the second public key and the third public key to the management server 4 (step S106). The public key exchange unit 232 of the host apparatus 2 stores, in the cipher key storage unit 221, the second public key received from the embedded controller 31, and transmits the second public key and the third public key stored in the cipher key storage unit 221 to the management server 4 through the NW communication unit 210. Thus, the server control unit 43 of the management server 4 stores, in the public key storage unit 423, the received second public key and third public key.

Note that the state in FIG. 6 illustrates the state of the information processing system 100 in which the processes up to step S106 are completed. In this state, as illustrated in FIG. 6, the laptop PC 1 (the embedded controller 31) holds the first public key, the second private key, and the second public key, and the host apparatus 2 holds the third private key, the third public key, and the second public key. Further, the management server 4 holds the first private key, the second public key, and the third public key.

Returning to the description of FIG. 4 again, the management server 4 next determines whether or not user authentication is OK (whether or not the user is legitimate) (step S107). The public key distribution unit 432 of the management server 4 determines whether or not the legitimacy of the user of the host apparatus 2 is confirmed by the user authentication unit 431. When the legitimacy of the user of the host apparatus 2 is confirmed (step S107: YES), the processing proceeds to step S108. Further, when the legitimacy of the user of the host apparatus 2 is not confirmed (step S107: NO), the public key distribution unit 432 returns the processing to step S107.

In step S108, the management server 4 generates a shared secret key from the first private key and the second public key. The common key generation unit 433 of the management server 4 generates the shared secret key K1 (first shared secret key) using Equation (4) described above. The common key generation unit 433 stores the generated shared secret key K1 (first shared secret key) in the common key storage unit 424.

Next, the public key distribution unit 432 of the management server 4 encrypts the third public key with the shared secret key (step S109). The public key distribution unit 432 encrypts the third public key with the shared secret key K1 (first shared secret key) using, for example, the AES or the like to generate encrypted data.

Note that the state in FIG. 7 illustrates the state of the information processing system 100 in which the processes up to step S109 are completed. In this state, as illustrated in FIG. 7, the laptop PC 1 (the embedded controller 31) holds the first public key, the second private key, and the second public key, and the host apparatus 2 holds the third private key, the third public key, and the second public key. Further, the management server 4 holds the first private key, the second public key, the third public key, the first shared secret key, and the encrypted data of the third public key.

Returning to the description of FIG. 4 again, the public key distribution unit 432 of the management server 4 next transmits the encrypted data of the third public key to the host apparatus 2 (step S110). The public key distribution unit 432 transmits the encrypted data of the third public key to the host apparatus 2 through the NW communication unit 41.

Next, the public key exchange unit 232 of the host apparatus 2 transmits the received encrypted data of the third public key to the embedded controller 31 through the NW communication unit 210 (step S111).

Next, the embedded controller 31 generates a shared secret key from the first public key and the second private key (step S112). The common key generation unit 315 of the embedded controller 31 generates the shared secret key K2 (second shared secret key) using Equation (5) described above. The common key generation unit 315 stores the generated shared secret key K2 (second shared secret key) in the common key storage unit 312.

Next, the public key exchange unit 314 of the embedded controller 31 decrypts the encrypted data of the third public key with the shared secret key (step S113). The public key exchange unit 314 decrypts the encrypted data of the third public key with the shared secret key K2 (second shared secret key), for example, using the AES or the like as the common key cryptography to generate the third public key. The public key exchange unit 314 stores the generated third public key in the cipher key storage unit 311.

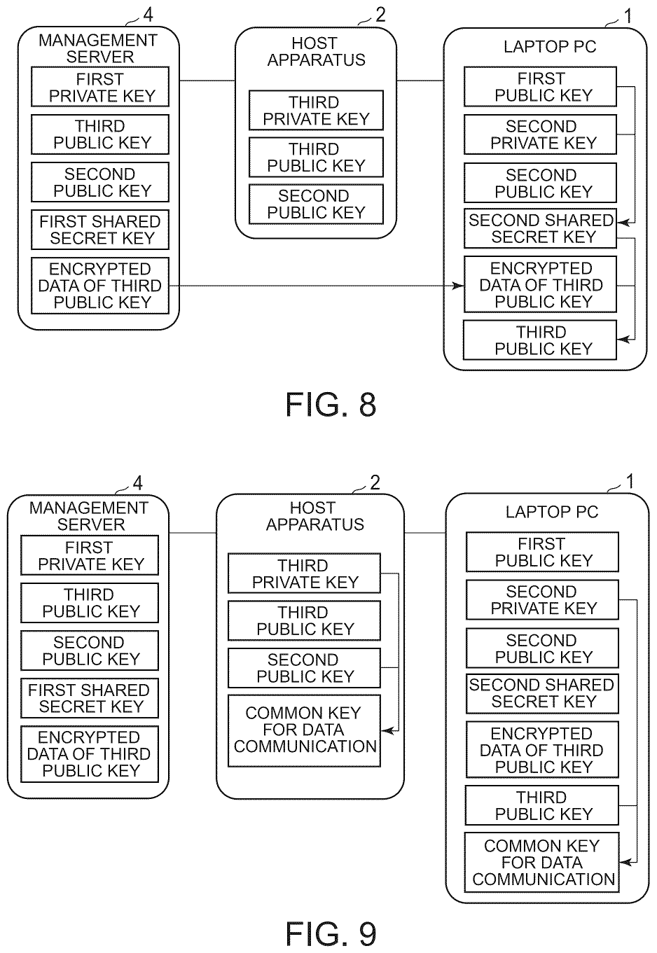

Note that the state in FIG. 8 illustrates the state of the information processing system 100 in which the processes up to step S113 are completed. In this state, as illustrated in FIG. 8, the laptop PC 1 (the embedded controller 31) holds the first public key, the second private key, the second public key, the second shared secret key, the encrypted data of the third public key, and the third public key, and the host apparatus 2 holds the third private key, the third public key, and the second public key. Further, the management server 4 holds the first private key, the second public key, the third public key, the first shared secret key, and the encrypted data of the third public key.

Note that the first shared secret key and the second shared secret key are the same value as expressed in Equation (6) described above.

Returning to the description of FIG. 4 again, the common key generation unit 315 of the embedded controller 31 next generates a common key for data communication from the second private key and the third public key (step S114). The common key generation unit 315 generates a common key for data communication (fourth shared secret key) using Equation (7) described above. The common key generation unit 315 stores the generated common key for data communication in the common key storage unit 312.

Next, the common key generation unit 233 of the host apparatus 2 generates a common key for data communication from the second public key and the third private key (step S115). The common key generation unit 233 generates the common key for data communication (third shared secret key) using Equation (8) described above. The common key generation unit 233 stores the generated common key for data communication in the common key storage unit 222.

Note that the state in FIG. 9 illustrates the state of the information processing system 100 in which the processes up to step S115 are completed. In this state, as illustrated in FIG. 9, the laptop PC 1 (the embedded controller 31) holds the first public key, the second private key, the second public key, the second shared secret key, the encrypted data of the third public key, the third public key, and the common key for data communication (fourth shared secret key K4), and the host apparatus 2 holds the third private key, the third public key, the second public key, and the common key for data communication (third shared secret key K3). Further, the management server 4 holds the first private key, the second public key, the third public key, the first shared secret key, and the encrypted data of the third public key.

Note that the third shared secret key K3 and the fourth shared secret key K4 are the same value as expressed in Equation (9) below.

$$K 3 = d 3 \times Q 2 ( x 2 , y 2 ) = d 3 \times d 2 \times G ( xg , yg ) = d 2 \times Q 3 ( x 3 , y 3 ) = K 4 \qquad ( 9 )$$

Returning to the description of FIG. 4 again, the update processing unit 234 of the host apparatus 2 next encrypts update data with the common key for data communication (step S116). The update processing unit 234 encrypts update data stored in the update program storage unit 223 with the common key for data communication stored in the common key storage unit 222, for example, using the AES or the like as the common key cryptography to generate encrypted update data (encrypted data of the update data).

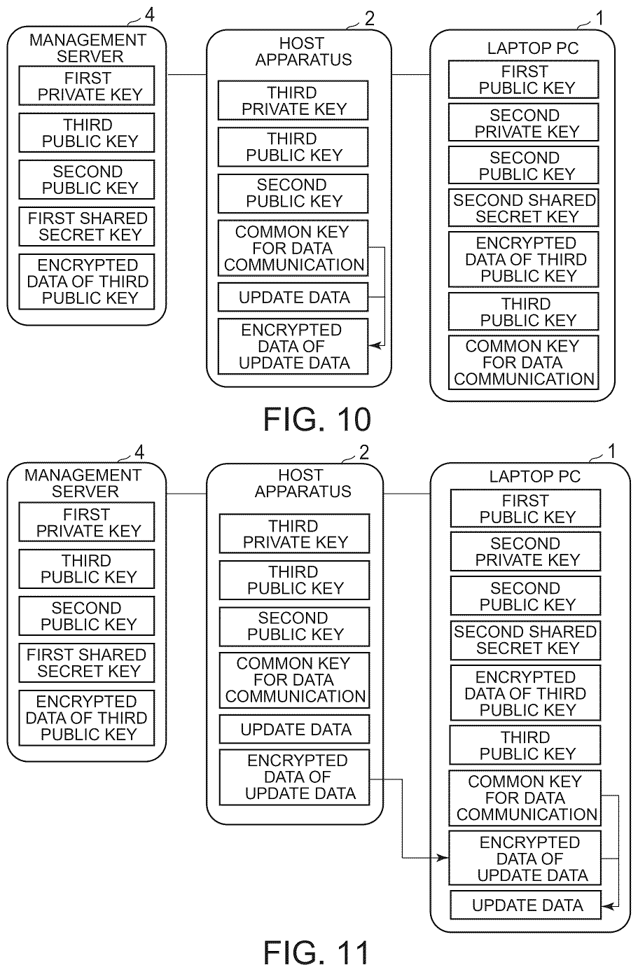

Note that the state in FIG. 10 illustrates the state of the information processing system 100 in which the processes up to step S116 are completed. In this state, as illustrated in FIG. 10, the laptop PC 1 (the embedded controller 31) holds the first public key, the second private key, the second public key, the second shared secret key, the encrypted data of the third public key, the third public key, and the common key for data communication, and the host apparatus 2 holds the third private key, the third public key, the second public key, the common key for data communication, the update data, and the encrypted data of the update data. Further, the management server 4 holds the first private key, the second public key, the third public key, the first shared secret key, and the encrypted data of the third public key.

Returning to the description of FIG. 4 again, the update processing unit 234 of the host apparatus 2 next transmits the encrypted data of the update data to the embedded controller 31 (step S117).

Next, the update processing unit 316 of the embedded controller 31 decrypts the encrypted data of the update data with the common key for data communication (step S118). The update processing unit 316 decrypts the encrypted data of the update data received from the host apparatus 2 with the common key for data communication stored in the common key storage unit 312, for example, using the AES or the like as the common key cryptography to generate the update data.

Note that the state in FIG. 11 illustrates the state of the information processing system 100 in which the processes up to step S118 are completed. In this state, as illustrated in FIG. 11, the laptop PC 1 (the embedded controller 31) holds the first public key, the second private key, the second public key, the second shared secret key, the encrypted data of the third public key, the third public key, the common key for data communication, the encrypted data of the update data, and the update data, and the host apparatus 2 holds the third private key, the third public key, the second public key, the common key for data communication, the update data, and the encrypted data of the update data. Further, the management server 4 holds the first private key, the second public key, the third public key, the first shared secret key, and the encrypted data of the third public key.

Returning to the description of FIG. 4 again, the update processing unit 316 of the embedded controller 31 next stores the decrypted update data in the BIOS memory 32 (step S119). The update processing unit 316 stores the update data in the BIOS program storage unit 321 to restore the BIOS program.

Note that in the processing illustrated in FIG. 4 described above, the processes of step S104 and step S105 correspond to first processing by the laptop PC 1, the processes of step S103 and step S106 correspond to second processing by the host apparatus 2. Further, the processes from step S107 to step S111 correspond to third processing by the management server, and the process in step S112 corresponds to fourth processing by the laptop PC 1.

Further, the processes from step S115 to step S117 correspond to fifth processing by the host apparatus 2, and the processes from step S112 to step S114 and the processes of step S118 and step S119 correspond to sixth processing by the laptop PC 1.

As described above, the information processing system 100 according to one or more embodiments includes the laptop PC 1 (information processing apparatus), the management server 4 (server apparatus), and the host apparatus 2 (upper apparatus). The laptop PC 1 (information processing apparatus) has the rewritable BIOS memory 32 (nonvolatile storage unit) which stores a program for booting up the OS to execute processing based on the OS. The management server 4 (server apparatus) manages the laptop PC 1. The host apparatus 2 (upper apparatus) can communicate with the laptop PC 1 and the management server 4 to transmit update data of the program to the laptop PC 1. The laptop PC 1 includes the registered public key storage unit 322 which stores a first public key corresponding to the laptop PC 1 in a first key pair of the first public key and a first private key held by the management server 4. Further, the information processing system 100 executes first processing, second processing, third processing, fourth processing, fifth processing, and sixth processing. In the first processing, the laptop PC 1 generates a second key pair of a second public key and a second private key, and transmits the second public key in the second key pair to the host apparatus 2. In the second processing, the host apparatus 2 generates a third key pair of a third public key and a third private key, and transmits the third public key in the third key pair and the second public key to the management server 4. In the third processing, the management server 4 generates encrypted data obtained by encrypting the third public key based on the first private key and the second public key when the legitimacy of a user of the upper apparatus is confirmed, and transmits the encrypted data to the laptop PC 1 through the host apparatus 2. In the fourth processing, the laptop PC 1 decrypts the encrypted data based on the first public key and the second private key to generate the third public key. In the fifth processing, the host apparatus 2 generates a common key for data communication based on the second public key and the third private key, encrypts update data based on the common key for data communication to generate encrypted update data, and transmits the encrypted update data to the laptop PC 1. In the sixth processing, the laptop PC 1 generates the common key for data communication based on the second private key and the third public key, decrypts the encrypted update data based on the common key for data communication to generate the update data, and updates the program stored in the BIOS memory 32 based on the update data.

Thus, when the legitimacy of the user of the host apparatus 2 is confirmed by the first processing to the fourth processing described above, since the laptop PC 1 can obtain the public key (third public key) of the host apparatus 2, the information processing system 100 according to one or more embodiments can prevent the BIOS program from being updated by an unauthorized user (and the host apparatus 2). Further, the information processing system 100 according to one or more embodiments can execute update processing of the BIOS program more securely by the fifth processing and the sixth processing. Therefore, the information processing system 100 according to one or more embodiments can update data of the nonvolatile memory (the BIOS memory 32) properly while ensuring security.

Further, for example, even when data of the nonvolatile memory (the BIOS memory 32) is so corrupted that the laptop PC 1 cannot be booted up, the information processing system 100 according to one or more embodiments can restore the data of the nonvolatile memory (the BIOS memory 32) securely by updating the data of the nonvolatile memory (the BIOS memory 32) properly.

Further, in one or more embodiments, the management server 4 generates a first shared secret key based on the first private key and the second public key, and encrypts the third public key based on the generated first shared secret key to generate the encrypted data in the third processing. Further, in the fourth processing, the laptop PC 1 generates a second shared secret key based on the first public key and the second private key, and decrypts the encrypted data based on the generated second shared secret key to generate the third public key.

Thus, since the common key (the first shared secret key=the second shared secret key) can be shared between the management server 4 and the laptop PC 1, the information processing system 100 according to one or more embodiments can transmit the third public key to the laptop PC 1 more securely by encrypting the third public key with the common key.

Further, in one or more embodiments, each of the first key pair, the second key pair, and the third key pair is a key pair of a public key and a private key in elliptic curve cryptography. The first shared secret key and the second shared secret key are an identical common key, and the common key is shared between the management server 4 and the laptop PC 1 using an elliptic curve Diffie-Hellman key exchange method. Further, the common key for data communication is shared between the host apparatus 2 and the laptop PC 1 using the elliptic curve Diffie-Hellman key exchange method.

Thus, the information processing system 100 according to one or more embodiments can share the common key between the management server 4 and the laptop PC 1 more securely, and can share the common key for data communication between the host apparatus 2 and the laptop PC 1 more securely. Therefore, the information processing system 100 according to one or more embodiments can update the data of the nonvolatile memory (the BIOS memory 32) properly while ensuring security.

Further, in one or more embodiments, the management server 4 encrypts the third public key using common key cryptography (for example, the AES), and the host apparatus 2 encrypts the update data using the common key cryptography (for example, the AES).

Thus, the information processing system 100 according to one or more embodiments can perform the transmission of the third public key and the update data to the laptop PC 1 securely while reducing the processing load of cryptographic processing.

Further, in one or more embodiments, the laptop PC 1 includes the main control unit 10 and the embedded controller 31 (sub control unit). The main control unit 10 boots up the OS by executing the program stored in the BIOS memory 32, and executes processing based on the OS. The embedded controller 31 (the sub control unit) is communicable with the host apparatus 2 and operable independently of the main control unit 10 to execute the first processing, the fourth processing, and the sixth processing.

Thus, the information processing system 100 according to one or more embodiments can execute the update processing of the BIOS program by using the embedded controller 31 (the sub control unit) without using the main control unit 10.

Further, in one or more embodiments, the BIOS program is included as the program stored in the BIOS memory 32. The BIOS memory 32 is a flash memory having a SPI bus. The embedded controller 31 updates the program of the BIOS in the flash memory using the SPI bus.

Thus, the information processing system 100 according to one or more embodiments can update (restore) the BIOS program from the embedded controller 31 properly using the SPI bus.

Further, the laptop PC 1 (information processing apparatus) according to one or more embodiments is the laptop PC 1 in the information processing system 100 including the laptop PC 1, the management server 4, and the host apparatus 2, where the laptop PC 1 includes the registered public key storage unit 322, the key pair generation unit 313, the public key exchange unit 314, the common key generation unit 315, and the update processing unit 316. Here, the management server 4 manages the laptop PC 1. The host apparatus 2 can communicate with the laptop PC 1 and the management server 4 to transmit update data of the program to the laptop PC 1. The laptop PC 1 has the rewritable BIOS memory 32 that stores the program for booting up the OS to execute processing based on the OS. The registered public key storage unit 322 stores the first public key corresponding to the laptop PC 1 in the first key pair of the first public key and the first private key held by the management server 4. The key pair generation unit 313 generates the second key pair of the second public key and the second private key. The public key exchange unit 314 acquires encrypted data generated by the management server 4 encrypting the third public key in the third key pair of the third public key and the third private key generated by the host apparatus 2 based on the first private key and the second public key after the second public key in the second key pair is transmitted to the host apparatus 2, decrypts the encrypted data based on the first public key stored in the registered public key storage unit 322 and the second private key to generate the third public key. The common key generation unit 315 generates the common key for data communication based on the third public key decrypted by the public key exchange unit 314 and the second private key. The update processing unit 316 decrypts the encrypted update data received from the host apparatus 2 based on the common key for data communication generated by the common key generation unit 315 to update the program stored in the BIOS memory 32 based on the decrypted update data.

Thus, the laptop PC 1 (information processing apparatus) according to one or more embodiments has the same effect as the information processing system 100 described above, and can update the data of the nonvolatile memory (the BIOS memory 32) properly while ensuring security.

Further, a data communication method according to one or more embodiments is a data communication method for the information processing system 100 including: the laptop PC 1 having the rewritable BIOS memory 32 which stores a program for booting up an OS to execute processing based on the OS; the management server 4 which manages the laptop PC 1; and the host apparatus 2 which can communicate with the laptop PC 1 and the management server 4 to transmit update data of the program to the laptop PC 1, the data communication method including a first processing step, a second processing step, a third processing step, a fourth processing step, a fifth processing step, and a sixth processing step. Note that the laptop PC 1 includes the registered public key storage unit 322 which stores a first public key corresponding to the laptop PC 1 in a first key pair of the first public key and a first private key held by the management server 4. In first processing step, the laptop PC 1 generates a second key pair of a second public key and a second private key, and transmits the second public key in the second key pair to the host apparatus 2. In the second processing step, the host apparatus 2 generates a third key pair of a third public key and a third private key, and transmits the third public key in the third key pair, and the second public key to the management server 4. In the third processing step, the management server 4 generates encrypted data obtained by encrypting the third public key based on the first private key and the second public key when the legitimacy of a user of the upper apparatus is confirmed, and transmits the encrypted data to the laptop PC 1 through the host apparatus 2. In the fourth processing step, the laptop PC 1 decrypts the encrypted data based on the first public key and the second private key to generate the third public key. In the fifth processing step, the host apparatus 2 generates a common key for data communication based on the second public key and the third private key, encrypts update data based on the common key for data communication to generate encrypted update data, and transmits the encrypted update data to the laptop PC 1. In the sixth processing step, the laptop PC 1 generates the common key for data communication based on the second private key and the third public key, decrypts the encrypted update data based on the common key for data communication to generate the update data, and updates the program stored in the BIOS memory 32 based on the update data.

Thus, the data communication method according to one or more embodiments has the same effect as the information processing system 100 described above, and can update the data of the nonvolatile memory (the BIOS memory 32) properly while ensuring security.

Note that the present invention is not limited to the aforementioned embodiments, and changes can be made without departing from the scope of the present invention.

For example, the example in which the information processing apparatus is the laptop PC 1 is described in the aforementioned embodiments, but the information processing apparatus is not limited to this example. For example, the information processing apparatus may also be any other type of information processing apparatus such as a tablet terminal, a desktop PC or the like. Further, the host apparatus 2 may also be any other type of information processing apparatus, rather than the laptop PC, such as a tablet terminal, a desktop PC or the like.

Further, in the aforementioned embodiments, the example in which each key pair of a public key and a private key is a key pair in elliptic curve cryptography is described, but the present invention is not limited to this example, and the key par may also be a key pair in any other public key cryptography.

Further, in the aforementioned embodiments, the example in which the third public key and the update data are encrypted and decrypted using the AES is described, but the present invention is not limited to this example, and any other common key cryptography or any other public key cryptography may also be used.

Further, in the aforementioned embodiments, the example in which encrypted data obtained by encrypting the third public key and the update data are transmitted to the laptop PC 1 is described, but the present invention is not limited to this example, and authentication information such as a digital signature generated from the third public key or the update data using cryptographic processing may also be added to the third public key and the update data and transmitted to the laptop PC 1.

Further, in the aforementioned embodiments, the example in which the management server 4 encrypts the third public key using the shared secret key and transmits encrypted data of the third public key to the laptop PC 1 is described, but the present invention is not limited to this example, and the management server 4 may also encrypt the third public key, for example, in public key cryptography using the first private key and the second public key, and transmit the encrypted data of the third public key to the laptop PC 1. In this case, the laptop PC 1 decrypts the encrypted data in public key cryptography using the second private key and the first public key to generate the third public key.

Further, in the aforementioned embodiments, the example of using the elliptic curve Diffie-Hellman key exchange method is described, but the present invention is not limited to this example. For example, in the case of any other public key cryptography such as the RSA cryptosystem, a common private key may be shared using a normal Diffie-Hellman key exchange method.

Note that each apparatus included in the information processing system 100 described above has a computer system therein. Then, a program for implementing the functions of each apparatus included in the information processing system 100 described above may be recorded on a computer-readable recording medium so that the program recorded on this recording medium is read into the computer system and executed to perform processing in each apparatus included in the information processing system 100 described above. Here, the fact that “the program recorded on the recording medium is read into the computer system and executed” includes installing the program on the computer system. It is assumed that the “computer system” here includes the OS and hardware such as peripheral devices and the like.

Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each apparatus included in the information processing system 100, or delivery servers for delivering respective split pieces of the program may be different from one another. Further, it is assumed that the “computer-readable recording medium” includes a medium on which the program is held for a given length of time, such as a volatile memory (RAN) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of each apparatus described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1 laptop PC
2 host apparatus
4 management server
10 main control unit
11 CPU
12 main memory
13 video subsystem
14 display unit
21 chipset
22 SSD
23 USB connector
24 audio system
25 WLAN card
31 embedded controller (EC)
32 BIOS memory
33 input unit
34 power supply circuit
41, 210 NW communication unit
42 server storage unit
43 server control unit
100 information processing system
101 BIOS processing unit
102 OS processing unit
220 apparatus storage unit
221, 311 cipher key storage unit
222, 312, 424 common key storage unit
223 update program storage unit
230 apparatus control unit
231, 313 key pair generation unit
232, 314 public key exchange unit
233, 315, 433 common key generation unit
234, 316 update processing unit
321 BIOS program storage unit
322 registered public key storage unit
421 registration information storage unit
422 authentication information storage unit
423 public key storage unit
431 user authentication unit
432 public key distribution unit
NW1 network

What is claimed is:

1. An information processing system comprising:
an information processing apparatus having a rewritable nonvolatile storage unit which stores a program for booting up an OS (Operating System) to execute processing based on the OS;
a server apparatus which manages the information processing apparatus; and
an upper apparatus which configured to communicate with the information processing apparatus and the server apparatus to transmit update data of the program to the information processing apparatus, wherein
the information processing apparatus includes a registered public key storage unit which stores a first public key corresponding to the information processing apparatus in a first key pair of the first public key and a first private key held by the server apparatus,
the information processing apparatus executes first processing to generate a second key pair of a second public key and a second private key and to transmit the second public key in the second key pair to the upper apparatus,
the upper apparatus executes second processing to generate a third key pair of a third public key and a third private key and to transmit the third public key in the third key pair and the second public key to the server apparatus,
the server apparatus executes third processing to generate encrypted data obtained by encrypting the third public key based on the first private key and the second public key when legitimacy of a user of the upper apparatus is confirmed, and to transmit the encrypted data to the information processing apparatus through the upper apparatus,
the information processing apparatus executes fourth processing to decrypt the encrypted data based on the first public key and the second private key so as to generate the third public key,
the upper apparatus executes fifth processing to generate a common key for data communication based on the second public key and the third private key, to encrypt the update data based on the common key for data communication so as to generate encrypted update data, and to transmit the encrypted update data to the information processing apparatus, and
the information processing apparatus executes sixth processing to generate the common key for data communication based on the second private key and the third public key, to decrypt the encrypted update data based on the common key for data communication so as to generate the update data, and to update the program stored in the nonvolatile storage unit based on the update data.

2. The information processing system according to claim 1, wherein
in the third processing, the server apparatus generates a first shared secret key based on the first private key and the second public key, and encrypts the third public key based on the generated first shared secret key to generate the encrypted data, and
in the fourth processing, the information processing apparatus generates a second shared secret key based on the first public key and the second private key, and decrypts the encrypted data based on the generated second shared secret key to generate the third public key.

3. The information processing system according to claim 2, wherein
each of the first key pair, the second key pair, and the third key pair is a key pair of a public key and a private key in elliptic curve cryptography,
the first shared secret key and the second shared secret key are an identical common key and the common key is shared between the server apparatus and the information processing apparatus using an elliptic curve Diffie-Hellman key exchange method, and
the common key for data communication is shared between the upper apparatus and the information processing apparatus using the elliptic curve Diffie-Hellman key exchange method.

4. The information processing system according to claim 3, wherein
the server apparatus encrypts the third public key using common key cryptography, and
the upper apparatus encrypts the update data using common key cryptography.

5. The information processing system according claim 1, wherein the information processing apparatus includes
a main control unit which boots up the OS by executing the program stored in the nonvolatile storage unit to execute processing based on the OS, and
a sub control unit communicable with the upper apparatus and operable independently of the main control unit to execute the first processing, the fourth processing, and the sixth processing.

6. The information processing system according to claim 5, wherein
a program of a BIOS (Basic Input Output System) is included as the program,
the nonvolatile storage unit is a flash memory having a SPI (Serial Peripheral Interface) bus, and
the sub control unit updates the program of the BIOS in the flash memory using the SPI bus.

7. An information processing apparatus for an information processing system including: the information processing apparatus having a rewritable nonvolatile storage unit which stores a program for booting up an OS (Operating System) to execute processing based on the OS; a server apparatus which manages the information processing apparatus; and an upper apparatus which configured to communicate with the information processing apparatus and the server apparatus to transmit update data of the program to the information processing apparatus, the information processing apparatus comprising:
a registered public key storage unit which stores a first public key corresponding to the information processing apparatus in a first key pair of the first public key and a first private key held by the server apparatus;
a key pair generation unit which generates a second key pair of a second public key and a second private key;
a public key exchange unit which acquires encrypted data generated by the server apparatus encrypting a third public key in a third key pair of the third public key and a third private key generated by the upper apparatus based on the first private key and the second public key after the information processing apparatus transmits the second public key in the second key pair to the upper apparatus, decrypts the encrypted data based on the first public key and the second private key stored in the registered public key storage unit to generate the third public key;
a common key generation unit which generates a common key for data communication based on the third public key decrypted by the public key exchange unit and the second private key; and
an update processing unit which decrypts the encrypted update data received from the upper apparatus based on the common key for data communication generated by the common key generation unit to update the program stored in the nonvolatile storage unit based on the decrypted update data.

8. A data communication method for an information processing system including: an information processing apparatus having a rewritable nonvolatile storage unit which stores a program for booting up an OS (Operating System) to execute processing based on the OS; a server apparatus which manages the information processing apparatus; and an upper apparatus configured to communicate with the information processing apparatus and the server apparatus to transmit update data of the program to the information processing apparatus, where the information processing apparatus includes a registered public key storage unit which stores a first public key corresponding to the information processing apparatus in a first key pair of the first public key and a first private key held by the server apparatus, the data communication method comprising:
a first processing step of causing the information processing apparatus to generate a second key pair of a second public key and a second private key and to transmit the second public key in the second key pair to the upper apparatus;
a second processing step of causing the upper apparatus to generate a third key pair of a third public key and a third private key and to transmit the third public key in the third key pair and the second public key to the server apparatus;
a third processing step of causing the server apparatus to generate encrypted data obtained by encrypting the third public key based on the first private key and the second public key when legitimacy of a user of the upper apparatus is confirmed, and to transmit the encrypted data to the information processing apparatus through the upper apparatus;
a fourth processing step of causing the information processing apparatus to decrypt the encrypted data based on the first public key and the second private key so as to generate the third public key;
a fifth processing step of causing the upper apparatus to generate a common key for data communication based on the second public key and the third private key, to encrypt the update data based on the common key for data communication so as to generate encrypted update data, and to transmit the encrypted update data to the information processing apparatus; and
a sixth processing step of causing the information processing apparatus to generate the common key for data communication based on the second private key and the third public key, to decrypt the encrypted update data based on the common key for data communication so as to generate the update data, and to update the program stored in the nonvolatile storage unit based on the update data.
